(19) United States
(12) Patent Application Publication
(10) Pub. No.: US 2020/0082285 A1
(43) Pub. Date: Mar. 12, 2020

(54) USER RECOMMENDATION METHOD AND DEVICE

(71) Applicant: SHANGHAI ZHANGMEN SCIENCE AND TECHNOLOGY CO., LTD., Shanghai (CN)

(72) Inventors: Shushan XIAO, Shanghai (CN); Fei WANG, Shanghai (CN)

(73) Assignee: SHANGHAI ZHANGMEN SCIENCE AND TECHNOLOGY CO., LTD., Shanghai (CN)

(21) Appl. No.: 16/687,723

(22) Filed: Nov. 19, 2019

Related U.S. Application Data
(63) Continuation of application No. PCT/CN2018/088990, filed on May 30, 2018.

(30) Foreign Application Priority Data
Oct. 23, 2017 (CN) 201710995008.X

(51) Int. Cl. G06N 5/04; G06F 16/9535; G06F 16/9536; G06F 16/906

(52) U.S. Cl. CPC G06N 5/04; G06F 16/906; G06F 16/9536; G06F 16/9535

(57) ABSTRACT

A user recommendation method and device, for determining regional activity record information about a target user according to connection record information about the target user establishing a connection to a wireless access point. A matching user corresponding to the target user is determined based on overlap of activity regions of different users, and then the matching user is provided to the target user. A user is recommended based on the connection record information about the user establishing the connection to the wireless access point. Further, the matching user corresponding to the target user is determined according to the regional activity record information of the target user and in combination with a plurality of user matching rules. Users are classified according to a plurality of flexible user matching rules, so that the users are more appropriately recommended, and user experience is optimized.

### CROSS REFERENCE TO THE RELATED APPLICATIONS

This application is the continuation application of International Application No. PCT/CN2018/088990, filed on May 30, 2018, which is based upon and claims priority to Chinese Patent Applications No. 201710361341.5 filed on May 19, 2017 and No. 201710995008.X filed on Oct. 23, 2017, the entire contents of which are incorporated herein by reference.

### TECHNICAL FIELD

This application relates to the communications field, and in particular, to a user recommendation technology.

### BACKGROUND

People are gregarious, and social contact is an eternal theme in human activities. With the development of science and technology, social products have developed rapidly in recent years. The most primary goal of all social products is to find a number of friends, especially a group of people who are relevant to themselves for chatting and establishing a stable relationship chain. In order to achieve the goal, each user is to be tagged with a relevant attribute, so that the user can find a friend he/she most wants to find on a social platform.

In addition, as people more and more frequently use mobile devices such as a smartphone and a tablet to surf the Internet, people often need to be connected to various wireless access points (such as wireless access points at home, in a company, in a shopping mall, in a station, or in an airport). However, at present, development of a related social relationship chain based on a connection record about a user establishing a connection to a wireless access point is not applied.

### SUMMARY

One objective of this application is to provide a user recommendation method and device.

According to one aspect of this application, a user recommendation method is provided. The method includes: determining, according to connection record information about a target user establishing a connection to a wireless access point, a matching user corresponding to the target user, the target user and the matching user having at least one same activity region or being connected to at least one same wireless access point; and providing the matching user to the target user.

According to another aspect of this application, a user recommendation device is provided. The device includes: a processor; and a memory configured to store a computer executable instruction that, when executed, causes the processor to perform the foregoing method.

According to still another aspect of this application, a user classification method is provided. The method includes: determining, according to connection record information about a target user establishing a connection to a wireless access point, regional activity record information about the target user; and determining, according to the regional activity record information, a matching user corresponding to the target user, the target user and the matching user constituting one or more user sets, and the target user and the matching user having at least one same activity region.

According to yet another aspect of this application, a user classification device is provided. The device includes: a processor; and a memory configured to store a computer executable instruction that, when executed, causes the processor to perform the foregoing method.

According to still yet another aspect of this application, a computer readable medium including an instruction is provided. The instruction, when executed, causes a system to perform an operation as described in the foregoing method.

In comparison to the prior art, in this application, regional activity record information about a target user is determined according to connection record information about the target user establishing a connection to a wireless access point, a matching user corresponding to the target user is determined based on overlap of activity regions of different users, and then the matching user is provided to the target user. According to this application, a user is recommended based on connection record information about the user establishing a connection to a wireless access point, to help the user develop a related social relationship chain, thereby improving user experience. Further, in this application, the matching user corresponding to the target user is determined according to the regional activity record information about the target user and in combination with a plurality of user matching rules. According to this application, users are classified according to a plurality of flexible user matching rules, so that the users are more appropriately recommended, and user experience is optimized.

### BRIEF DESCRIPTION OF THE DRAWINGS

Other features, objectives, and advantages of this application will become more obvious by reading the detailed description of non-limiting embodiments that is provided with reference to the following accompanying drawings:

FIG. 1 is a flowchart of a user recommendation method according to an embodiment of this application;

FIG. 2 is a flowchart of a user classification method according to another embodiment of this application.

The same or similar reference numerals in the drawings indicate the same or similar parts.

### DETAILED DESCRIPTION OF THE EMBODIMENTS

The following further describes this application in detail with reference to accompanying drawings.

In a typical configuration in this application, each of a terminal, a service network device, and a trusted party includes one or more processors (CPUs), an input/output interface, a network interface, and a memory.

The memory may include, among computer readable media, a non-persistent memory such as a random access memory (RAM) and/or a non-volatile memory such as a read-only memory (ROM) or a flash memory (flash RAM). The memory is an example of the computer-readable medium.

The computer-readable medium includes persistent, non-persistent, movable, and unmovable media that may implement information storage by using any method or technology. Information may be a computer-readable instruction, a data structure, a program module, or other data. Computer storage media may be configured to store information that a computing device can access, of which examples include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media.

A device 1 and a device 2 in this application include but are not limited to a user equipment, a network device, or a device formed by integrating the user equipment and the network device through a network. The user equipment includes, but is not limited to, any mobile electronic product that can perform human-computer interaction with a user, such as a smart phone, a tablet computer, and the like, and the mobile electronic product can adopt any operating system, such as an android operating system, an iOS operating system, a Windows operating system, and the like. The network device includes an electronic device capable of automatically performing numerical calculation and information processing according to an instruction set or stored in advance, and hardware of the network device includes but is not limited to a microprocessor, an application specific integrated circuit (ASIC), a programmable logic device (PLD), a field programmable gate array (FPGA), a digital signal processor (DSP), an embedded device, and the like. The network device includes, but is not limited to, a computer, a network host, a single network server, a plurality of network server sets, or a cloud composed of a plurality of servers. In this case, the cloud is composed of a large quantity of computers or network servers based on cloud computing. Cloud computing is a type of distributed computing, and is a virtual supercomputer composed of a group of loosely coupled computer sets. The network includes, but is not limited to, the Internet, a wide area network, a metropolitan area network, a local area network, a VPN network, a wireless ad hoc network, and the like. Preferably, the device 1 and the device 2 may also be a program running on the user equipment, the network device, or the user equipment and the network device, the network device, a touch terminal, or a device formed by integrating the network device and the touch terminal through a network.

Certainly, a person skilled in the art should understand that the device 1 and the device 2 above are only examples, and other existing or future devices, if applicable to this application, shall also be included in the protection scope of this application and hereby incorporated by reference.

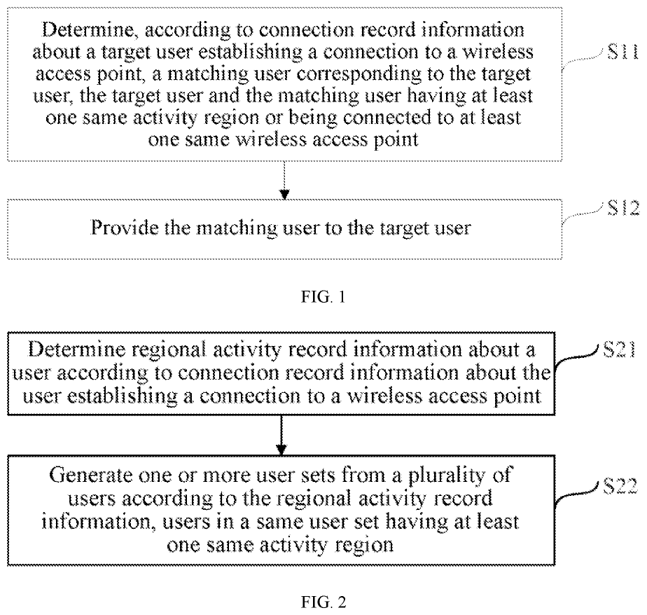

FIG. 1 is a flowchart of a user recommendation method according to an embodiment of this application. The method includes step S11 and step S12.

In particular, in step S11, a device 1 determines, according to connection record information about a target user establishing a connection to a wireless access point, a matching user corresponding to the target user. The target user and the matching user have at least one same activity region or are connected to at least one same wireless access point. In step S12, the device 1 provides the matching user to the target user.

For example, a cloud server for a specific application (such as an application for establishing a connection to a wireless access point) stores connection record information about a plurality of users who use the specific application and establish a connection to the wireless access point (for example, establish a connection to a specific wireless access point at a specific time). In an embodiment, the device 1 may determine activity regions of the users according to the connection record information about the plurality of users (including the target user and the matching user) establishing a connection to the wireless access point, and hereby classify the plurality of users to form one or more user sets. Alternatively, the device 1 may determine, according to the connection record information about the plurality of users (including the target user and the matching user) establishing a connection to the wireless access point, whether different users are connected to a same wireless access point, so as to classify the plurality of users and form one or more user sets. One user may fall within one or more user sets.

Herein, connection record information about a user establishing a connection to a wireless access point includes but is not limited to starting and ending time information, connection duration information, or the like about the user establishing a connection to a wireless access point. The connection record information may be directly read from a third-party device, or acquired by the device 1 from a large number of wireless connection logs in real time. For example, a plurality of wireless connection logs (such as starting and ending time, or the like about a user equipment establishing a connection to a wireless connection point) of the user equipment is matched from the large number of wireless connection logs according to device identifier information (such as MAC address information of the user equipment) of the user equipment used by the user, and the wireless connection logs are statistically processed to obtain the connection record information about the user establishing a connection to the wireless access point.

After a user set is generated, the device 1 recommends other users in the user set to a user in the user set. Preferably, the user may select whether recommendation is allowed, and whether recommendation is accepted. The device 1 provides the user set to a user who is allowed to be recommended in the user set.

In another embodiment, the device 1 may also directly determine, according to the connection record information, the matching user corresponding to the target user without classifying the user set. There may be one or more matching users. Afterwards, the device 1 recommends the matching user to the target user.

Preferably, in step S11, the device 1 determines regional activity record information about the target user according to the connection record information about the target user establishing a connection to the wireless access point; and determines, according to the regional activity record information, the matching user corresponding to the target user. The target user and the matching user have at least one same activity region.

For example, a wireless router corresponding to the wireless access point is generally at a fixed geographical position, and therefore the user equipment may be connected to a corresponding wireless access point within a specific range near the wireless router. If a user equipment carried by the user is connected to a wireless access point W at a time T, a region that the wireless access point W belongs to may be determined as an activity region of the user at the time T. Therefore, the device 1 may determine the regional activity record information about the target user according to the connection record information about the target user establishing a connection to the wireless access point.

Preferably, that the device 1 determines regional activity record information about the target user according to the connection record information about the target user establishing a connection to the wireless access point includes: the device 1 determines the regional activity record information about the target user according to the connection record information about the target user establishing a connection to the wireless access point and a region that the wireless access point belongs to.

For example, the region that the wireless access point belongs to may be determined according to an IP address of the wireless access point. Alternatively, a hotspot database of a specific application (such as an application for establishing a connection to a wireless access point) may be queried to determine the region that the wireless access point belongs to.

Preferably, that the device 1 determines the regional activity record information about the target user according to the connection record information about the target user establishing a connection to the wireless access point and a region that the wireless access point belongs to includes: the device 1 determines the region that each wireless access point belongs to in the connection record information about the target user establishing a connection to the wireless access point; and determines the regional activity record information about the target user according to the connection record information and the region that each wireless access point belongs to.

For example, if connection record information about a user A includes: establishing a connection to a wireless access point W1 at a time T1, establishing a connection to a wireless access point W2 at a time T2, establishing a connection to a wireless access point W3 at a time T3, . . . , and establishing a connection to a wireless access point Wn at a time Tn, the device 1 determines regions that the wireless access points W1, W2, W3, . . . , and Wn belong to, and further determines that the user A is in a region that the wireless access point W1 belongs to at the time T1, is in a region that the wireless access point W2 belongs to at the time T2, . . . , and is in a region that the wireless access point Wn belongs to at the time Tn.

Preferably, the region that the wireless access point belongs to includes at least one of the following: an administrative planning region; and a plurality of divided regions in a map.

For example, the region that the wireless access point belongs to may be distinguished according to an administrative planning district (county), town (township), and street (village). Alternatively, the map may be divided into a plurality of square areas, and the region that the wireless access point belongs to may be distinguished based on the square areas.

Preferably, that the device 1 determines, according to the regional activity record information, the matching user corresponding to the target user includes: the device 1 determines, according to the regional activity record information and in combination with a user matching rule, the matching user corresponding to the target user, the target user and the matching user having at least one same activity region.

For example, the user matching rule includes: the target user and the matching user have at least one same activity region. For example, assuming that a generation rule of a user set A′ includes: all users in the user set A′ went to a region A, if the target user and the matching user went to the region A, the target user and the matching user conform to the user matching rule. In addition, the user matching rule may further include other content.

Preferably, the user matching rule includes at least one of the following: both the target user and the matching user relate to a specified activity region, both the target user and the matching user have at least two same activity regions, both the target user and the matching user have at least one same activity region sequence, both the target user and the matching user relate to a specified activity region within a target time period, both the target user and the matching user have at least two same activity regions within the target time period, and both the target user and the matching user have at least one same activity region sequence within the target time period.

For example, assuming that the specified activity region is a region B and users who went to the region B are classified into a same user set B′, if both the target user and the matching user went to the region B, the target user and the matching user conform to the user matching rule. Users who went to a region C and a region D are classified into a same user set C′D′, and if both the target user and the matching user went to the region C and the region D, the target user and the matching user conform to the user matching rule. Users who have an activity region sequence E→F (that is, from a region E to a region F) are classified into a same user set E″F′(for example, users having activity sequences E→F→E, E→F→B, C→E→F, and E→D→F may be classified into the user set E″F′), and if both the target user and the matching user have the activity region sequence E→F, the target user and the matching user conform to the user matching rule. Assuming that the target time period is Tx (such as 8:00-18:00 per Monday, or 10:00-20:00 per Saturday), the specified activity region is a region G and users who went to the region G within the target time period Tx are classified into a same user set G′, if both the target user and the matching user went to the region G within the target time period Tx, the target user and the matching user conform to the user matching rule. Assuming that the target time period is Ty and users who when to a region H and a region I within the target time period Ty are classified into a same user set H′I′, if both the target user and the matching user went to the region H and the region I within the target time period Ty, the target user and the matching user conform to the user matching rule. Assuming that the target time period is Tz and users who have an activity region sequence J→K (that is, from a region J to a region K) within the target time period Tz are classified into a same user set J″K′ (for example, users having activity sequences J→K→J, J→K→B, C→J→K and J→D→K within the target time period Tz may be classified into the user set J″K′), if both the target user and the matching user have the activity region sequence J→K within the target time period Tz, the target user and the matching user conform to the user matching rule.

For another example, assuming that a person surnamed Zhao goes to a movie theater from home to watch a movie every Saturday, if a person surnamed Qian who lives near the home of the person surnamed Zhao also goes to the movie theater from home to watch a movie every Saturday, the person surnamed Zhao and the person surnamed Qian conform to the user matching rule. Assuming that a person surnamed Sun goes to a movie theater from home to watch a movie at 2:00 p.m. every Saturday, if a person surnamed Li who lives near the home of the person surnamed Sun also goes to the movie theater from home to watch a movie at about 2:00 p.m. every Saturday, the person surnamed Sun and the person surnamed Li conform to the user matching rule. Assuming that a person surnamed Zhou goes to a movie theater from home to watch a movie and then goes to a library every Saturday, if a person surnamed Wu who lives near the home of the person surnamed Zhou also goes to the movie theater from home to watch a movie and then goes to the library every Saturday, the person surnamed Zhou and the person surnamed Wu conform to the user matching rule. Assuming that a person surnamed Zheng goes to a movie theater from home to watch a movie at 2:00 and then goes to a library every Saturday, if a person surnamed Wang who lives near the home of the person surnamed Zheng also goes to the movie theater from home to watch a movie at about 2:00 and then goes to the library every Saturday, the person surnamed Zheng and the person surnamed Wang conform to the user matching rule.

Preferably, the method further includes: providing, by the device 1 according to connection record information about a third user establishing a connection to a wireless access point, the third user to the target user if the third user is the matching user corresponding to the target user.

For example, the third user may be a new user of a specific application (such as an application for establishing a connection to a wireless access point), it is determined, according to connection record information about the new user establishing a connection to the wireless access point, whether the new user matches the target user, or the new user is classified into an existing user set. The third user may match one or more target users.

Preferably, the providing, by the device 1 according to connection record information about a third user establishing a connection to a wireless access point, the third user to the target user if the third user is the matching user corresponding to the target user includes: determining, by the device 1, regional activity record information about the third user according to the connection record information about the third user establishing a connection to the wireless access point, and if the third user is the matching user corresponding to the target user, providing the third user to the target user according to the regional activity record information.

For example, it is assumed that the target user went to the region C and the region D, there is a wireless access point Wc in the region C, and there is a wireless access point Wd in the region D. If the connection record information about the third user includes the wireless access points Wc and Wd, it may be determined that the third user went to the region C and the region D, and it may be further determined that the third user is the matching user corresponding to the target user.

For another example, it is assumed that users in the user set C′D′ went to both the region C and the region D, there is a wireless access point Wc in the region C, and there is a wireless access point Wd in the region D. If the connection record information about the third user includes the wireless access points Wc and Wd, it may be determined that the third user went to the region C and the region D, and the target user is further classified into the user set C′D′.

According to another aspect of this application, a user recommendation device is provided. The device includes: a processor; and a memory configured to store a computer executable instruction that, when executed, causes the processor to perform the foregoing method.

FIG. 2 is a flowchart of a user classification method according to another embodiment of this application. The method includes step S21 and step S22.

In particular, in step S21, a device 2 determines regional activity record information about a user according to connection record information about the user establishing a connection to a wireless access point. In step S22, the device 2 generates one or more user sets from a plurality of users according to the regional activity record information, users in a same user set including at least one same activity region.

For example, a cloud server for a specific application (such as an application for establishing a connection to a wireless access point) stores connection record information about a plurality of users establish a connection to the wireless access point using the specific application (for example, establish a connection to a specific wireless access point at a specific time).

A wireless router corresponding to the wireless access point is generally at a fixed geographical position, and therefore a user equipment may be connected to a corresponding wireless access point within a specific range near the wireless router. If a user equipment carried by the user is connected to a wireless access point W at a time T, a region that the wireless access point W belongs to may be determined as an activity region of the user at the time T. Therefore, the device 2 may determine the regional activity record information about the user according to the connection record information about the user establishing a connection to the wireless access point.

The device 2 classifies a plurality of users according to regional activity record information about the plurality of users to generate one or more user sets. One user may fall within one or more user sets.

In some embodiments, the method further includes step S23 (not shown): the device 2 recommends the user set to at least one user in the user set. For example, the generated user set includes users u1, u2, u3 and u4. The device 2 recommends the user set to the user u2 to help the user u2 establish an offline social interaction with other users (such as u1, u3, and u4) in the user set.

Preferably, that a device 2 determines regional activity record information about a user according to connection record information about the user establishing a connection to a wireless access point includes: the device 2 determines the regional activity record information about the user according to the connection record information about the user establishing a connection to the wireless access point and a region that the wireless access point belongs to.

For example, the region that the wireless access point belongs to may be determined according to an IP address of the wireless access point. Alternatively, a hotspot database of a specific application (such as an application for establishing a connection to a wireless access point) may be queried to determine the region that the wireless access point belongs to.

Preferably, that the device 2 determines the regional activity record information about the user according to the connection record information about the user establishing a connection to the wireless access point and a region that the wireless access point belongs to includes: the device 2 determines a region that each wireless access point belongs to in the connection record information about the user establishing a connection to the wireless access point; and determines the regional activity record information about the user according to the connection record information about user establishing a connection to the wireless access point and the region that each wireless access point belongs to.

For example, if connection record information about a user A includes: establishing a connection to a wireless access point W1 at a time T1, establishing a connection to a wireless access point W2 at a time T2, establishing a connection to a wireless access point W3 at a time T3, . . . , and establishing a connection to a wireless access point Wn at a time Tn, the device 2 determines regions that the wireless access points W 1, W2, W3, . . . , and Wn belong to, and further determines that the user A is in a region that the wireless access point W1 belongs at the time T1, is in a region that the wireless access point W2 belongs at the time T2, . . . , is in a region that the wireless access point Wn belongs at the time Tn.

Preferably, the region that the wireless access points belong to includes at least one of the following: an administrative planning region; and a plurality of divided regions in a map.

For example, the region that the wireless access point belongs to may be distinguished according to an administrative planning district (county), town (township), and street (village). Alternatively, the map may be divided into a plurality of square areas, and the region that the wireless access point belongs to may be distinguished based on the square areas.

Preferably, that the device 2 generates one or more user sets from a plurality of users according to the regional activity record information includes: the device 2 generates the one or more user sets from the plurality of users g according to the regional activity record information and in combination with a user set generation rule, users in a same user set having at least one same activity region.

For example, the user set generation rule includes: users in a same user set have at least one same activity region. For example, it is assumed that a generation rule of a user set A′ includes: all users in the user set A′ went to a region A. In addition, the user set generation rule may further include other content.

Preferably, the user set generation rule includes at least one of the following: the users in the same user set relate to a specified activity region, the users in the same user set have at least two same activity regions, the users in the same user set have at least one same activity region sequence, the users in the same user set relate to the specified activity region within a target time period, the users in the same user set have at least two same activity regions within the target time period, and the users in the same user set have at least one same activity region sequence within the target time period.

For example, if the specified activity region is a region B, users who went to the region B are classified into a same user set, and users who went to a region C and a region D are classified into a same user set C′D′. Users who have an activity region sequence E→F (that is, from a region E to a region F) are classified into a same user set E″F′ (for example, users having activity sequences E→F→E, E→F→B, C→E→F, and E→D→F may be classified into the user set E″F′). If the target time period is Tx (such as 8:00-18:00 per Monday, or 10:00-20:00 per Saturday), and the specified activity region is a region G, users who went to the region G within the target time period Tx are classified into a same user set G′. If the target time period is Ty, users who when to both a region H and a region I within the target time period Ty are classified into a same user set H′I′.

If the target time period is Tz, users who have an activity region sequence J→K (that is, from a region J to a region K) within the target time period Tz are classified into a same user set J″K′ (for example, users having activity sequences J→K→J, J→K→B, C→J→K and J→D→K within the target time period Tz may be classified into the user set J″K′).

For another example, assuming that a person surnamed Zhao goes to a movie theater from home to watch a movie every Saturday, if a person surnamed Qian who lives near the home of the person surnamed Zhao also goes to the movie theater from home to watch a movie every Saturday, the person surnamed Zhao and the person surnamed Qian are classified into a same user set. Assuming that a person surnamed Sun goes to a movie theater from home to watch a movie at 2:00 p.m. every Saturday, if a person surnamed Li who lives near the home of the person surnamed Sun also goes to the movie theater from home to watch a movie at about 2:00 p.m. every Saturday, the person surnamed Sun and the person surnamed Li are classified into a same user set. Assuming that a person surnamed Zhou goes to a movie theater from home to watch a movie and then goes to a library every Saturday, if a person surnamed Wu who lives near the home of the person surnamed Zhou also goes to the movie theater from home to watch a movie and then goes to the library every Saturday, the person surnamed Zhou and the person surnamed Wu are classified into a same user set. Assuming that a person surnamed Zheng goes to a movie theater from home to watch a movie at 2:00 and then goes to a library every Saturday, if a person surnamed Wang who lives near the home of the person surnamed Zheng also goes to the movie theater from home to watch a movie at about 2:00 and then goes to the library every Saturday, the person surnamed Zheng and the person surnamed Wang are classified into a same user set.

Preferably, the method further includes: classifying, by the device 2, a target user into at least one user set according to connection record information about the target user establishing a connection to a wireless access point.

For example, the target user may be a new user of a specific application (such as an application for establishing a connection to a wireless access point), and the new user is classified into an existing user set according to connection record information about the new user establishing a connection to the wireless access point. The target user may fall within one or more user sets.

Preferably, the classifying, by the device 2, a target user into at least one user set according to connection record information about the target user establishing a connection to a wireless access point includes: determining, by the device 2, regional activity record information about the target user according to the connection record information about the target user establishing a connection to the wireless access point, and classifying the target user into the at least one user set according to the regional activity record information.

For another example, it is assumed that users within the user set C′D′ went to both the region C and the region D, there is a wireless access point Wc in the region C, and there is a wireless access point Wd in the region D. If the connection record information about the target user includes the wireless access points Wc and Wd, it may be determined that the target user went to the region C and the region D, and the target user is further classified into the user set C′D′.

According to yet another aspect of this application, a user classification device is provided. The device includes: a processor; and a memory configured to store a computer executable instruction that, when executed, causes the processor to perform the foregoing method.

According to still yet another aspect of this application, a computer readable medium including an instruction is provided. The instruction, when executed, causes a system to perform an operation as described in the foregoing method.

In comparison to the prior art, in this application, regional activity record information about a target user is determined according to connection record information about the target user establishing a connection to a wireless access point, a matching user corresponding to the target user is determined based on overlap of activity regions of different users, and then the matching user is provided to the target user. According to this application, a user is recommended based on connection record information about the user establishing a connection to a wireless access point, to help the user develop a related social relationship chain, thereby improving user experience. Further, in this application, the matching user corresponding to the target user is determined according to the regional activity record information about the target user and in combination with a plurality of user matching rules. According to this application, users are classified according to a plurality of flexible user matching rules, so that the users are more appropriately recommended, and user experience is optimized.

It should be noted that this application may be implemented in software and/or a combination of software and hardware, for example, may be implemented by using an application specific integrated circuit (ASIC), a general-purpose computer, or another similar hardware device. In an embodiment, the software program in this application may be executed by a processor to implement the steps or functions described above. Similarly, the software program (including related data structures) in this application may be stored in a computer-readable recording medium such as a RAM memory, a magnetic or optical drive or a floppy disk, and the like. In addition, some of the steps or functions of this application may be implemented in hardware, for example, a circuit that cooperates with a processor to perform the steps or functions.

In addition, a part of this application may be applied to a computer program product, such as a computer program instruction. The computer program instruction, when executed by a computer, may invoke or provide a method and/or technical solution according to this application by operations of the computer. A person skilled in the art should understand that a form of the computer program instruction in the computer-readable medium includes, but is not limited to, a source file, an executable file, an installation package file, and the like. Accordingly, a manner in which the computer program instruction is executed by the computer includes, but is not limited to: The computer directly executes the instruction, or the computer compiles the instruction and then executes the corresponding compiled program, or the computer reads and executes the instruction, or the computer reads and installs the instruction and then executes the corresponding installed program. In this case, the computer-readable medium may be any available computer readable-storage medium or communication medium that can be accessed by the computer.

Communication media include media that can be transferred from one system to another system by communication signals including, for example, computer-readable instructions, data structures, program modules, or other data. Communication media may include conductive transmission media (such as cables and wires (for example, fiber optics, coaxial, and the like)) and wireless (transmission without conduction) media capable of propagating energy waves such as acoustic, electromagnetic, RF, microwave, and infrared. Computer readable instructions, data structures, program modules, or other data may be embodied, for example, as modulated data signals in a wireless medium (such as a carrier wave or a similar mechanism embodied as a part of the spread spectrum technology). The term “modulated data signal” refers to a signal whose one or more features are altered or set in such a manner as to encode information in the signal. Modulation may be analog, digital or hybrid modulation techniques.

As an example instead of limitation, the computer-readable storage medium includes volatile and non-volatile media, and removable and non-removable media implemented by using any method or technology for storing information such as computer-readable instructions, data structures, program modules, or other data. For example, the computer-readable storage medium includes, but is not limited to, volatile memories such as random access memories (RAM, DRAM, SRAM); and nonvolatile memories such as a flash memory, various read only memories (ROM, PROM, EPROM, EEPROM), magnetic and ferromagnetic/ferroelectric memories (MRAM, FeRAM); and magnetic and optical storage devices (hard disk, magnetic tape, CD, DVD); or other currently known media or media developed in the future and capable of storing computer-readable information/data used by computer systems.

It is apparent to a person skilled in the art that this application is not limited to details of the above exemplary embodiments, and this application may be implemented in other implementations without departing from the spirit or basic features of this application. Therefore, the embodiments should be considered as exemplary and non-limiting from any point of view. The scope of this application is defined by the appended claims rather than the above descriptions. Therefore, all changes that fall within the meaning and scope of equivalents of the claims are included in this application. Any reference signs in the claims should not be construed as limiting the claims. In addition, it is apparent that the word “include” does not exclude other elements or steps and the singular does not exclude the plural. The words such as first, second, and the like are used to denote names and do not denote any particular order.

What is claimed is:

1. A user recommendation method, comprising:
determining, according to connection record information about a target user establishing a connection to a wireless access point, a matching user corresponding to the target user, wherein the target user and the matching user have at least one same activity region or had connected to at least one same wireless access point; and
providing the matching user to the target user.

2. The method according to claim 1, wherein the step of determining, according to connection record information about the target user establishing the connection to the wireless access point, the matching user corresponding to the target user comprises:
determining regional activity record information of the target user according to the connection record information about the target user establishing the connection to the wireless access point; and
determining, according to the regional activity record information, the matching user corresponding to the target user, wherein the target user and the matching user have at least one same activity region.

3. The method according to claim 2, wherein the step of determining, according to the regional activity record information, the matching user corresponding to the target user comprises:
determining, according to the regional activity record information and in combination with a user matching rule, the matching user corresponding to the target user, wherein the target user and the matching user have at least one same activity region.

4. The method according to claim 3, wherein the user matching rule comprises at least one selected from the group consisting of:
both the target user and the matching user relating to a specified activity region;
the target user and the matching user having at least two same activity regions;
the target user and the matching user having at least one same activity region sequence;
both the target user and the matching user relating to a specified activity region within a target time period;
the target user and the matching user having at least two same activity regions within a target time period; and
the target user and the matching user having at least one same activity region sequence within a target time period.

5. The method according to claim 2, wherein the step of determining the regional activity record information of the target user according to the connection record information about the target user establishing the connection to the wireless access point comprises:
determining the regional activity record information of the target user according to a region that the wireless access point belongs to and the connection record information about the target user establishing the connection to the wireless access point.

6. The method according to claim 5, wherein the step of determining the regional activity record information of the target user according to the region that the wireless access point belongs to and the connection record information about the target user establishing the connection to the wireless access point comprises:
determining a region that each wireless access point recorded in the connection record information belongs to; and
determining the regional activity record information of the target user according to the connection record information and the region that each wireless access point recorded in the connection record information belongs to.

7. The method according to claim 5, wherein the region that the wireless access point belongs to comprises at least one selected from the group consisting of:
an administrative planning region; and
one of a plurality of divided regions in a map.

8. The method according to claim 1, further comprising:
providing a third user to the target user if the third user is the matching user corresponding to the target user according to connection record information about the third user establishing the connection to the wireless access point.

9. The method according to claim 8, wherein the step of providing the third user to the target user if the third user is the matching user corresponding to the target user according to the connection record information about the third user establishing the connection to the wireless access point comprises:
determining regional activity record information of the third user according to the connection record information about the third user establishing the connection to the wireless access point; and
providing the third user to the target user if the third user is the matching user corresponding to the target user according to the regional activity record information.

10. A user classification method, comprising:
determining the regional activity record information of the user according to connection record information about the user establishing the connection to the wireless access point; and
generating at least one user set according to the regional activity record information of a plurality of users, wherein users in a same user set have at least one same activity region.

11. The method according to claim 10, further comprising:
recommending the at least one user set to at least one user in the at least one user set.

12. A non-transient computer readable medium comprising an instruction, for causing a system to perform an operation of the method of claim 1.

13. The method according to claim 3, wherein the step of determining the regional activity record information of the target user according to the connection record information about the target user establishing the connection to the wireless access point comprises:
determining the regional activity record information of the target user according to the region that the wireless access point belongs to and the connection record information about the target user establishing the connection to the wireless access point.

14. The method according to claim 4, wherein the step of determining the regional activity record information of the target user according to the connection record information about the target user establishing the connection to the wireless access point comprises:
determining the regional activity record information of the target user according to the region that the wireless access point belongs to and the connection record information about the target user establishing the connection to the wireless access point.

15. The non-transient computer readable medium according to claim 12, wherein the step of determining, according to connection record information about the target user establishing the connection to the wireless access point, the matching user corresponding to the target user, comprises:
determining regional activity record information of the target user according to the connection record information about the target user establishing the connection to the wireless access point; and
determining, according to the regional activity record information, the matching user corresponding to the target user, wherein the target user and the matching user have at least one same activity region.

16. The non-transient computer readable medium according to claim 15, wherein, the step of determining, according to the regional activity record information, the matching user corresponding to the target user, comprises:
determining, according to the regional activity record information and in combination with the user matching rule, the matching user corresponding to the target user, wherein the target user and the matching user have at least one same activity region.

17. The non-transient computer readable medium according to claim 16, wherein the user matching rule comprises at least one selected from the group consisting of:
both the target user and the matching user relating to the specified activity region;
the target user and the matching user having at least two same activity regions;
the target user and the matching user having at least one same activity region sequence;
both the target user and the matching user relating to the specified activity region within the target time period;
the target user and the matching user having at least two same activity regions within the target time period; and
the target user and the matching user having at least one same activity region sequence within the target time period.

18. The non-transient computer readable medium according to claim 15, wherein the step of determining the regional activity record information of the target user according to the connection record information about the target user establishing the connection to the wireless access point, comprises:
determining the regional activity record information of the target user according to the region that the wireless access point belongs to and the connection record information about the target user establishing the connection to the wireless access point.

19. The non-transient computer readable medium according to claim 18, wherein the step of determining the regional activity record information of the target user according to the region that the wireless access point belongs to and the connection record information about the target user establishing the connection to the wireless access point, comprises:
determining the region that each wireless access point recorded in the connection record information belongs to; and
determining the regional activity record information of the target user according to the connection record information and the region that each wireless access point recorded in the connection record information belongs to.

20. The non-transient computer readable medium according to claim 18, wherein the region that the wireless access point belongs to comprises at least one selected from the group consisting of
the administrative planning region; and
one of the plurality of divided regions in the map.
